(19) United States
(12) Patent Application Publication
(10) Pub. No.: US 2025/0091418 A1
(43) Pub. Date: Mar. 20, 2025

(54) GLASS RUN

(71) Applicant: TOYODA GOSEI CO., LTD., Kiyosu-shi (JP)

(72) Inventors: Daiki Nagai, Kiyosu-shi (JP); Tasuku Ishiguro, Kiyosu-shi (JP)

(21) Appl. No.: 18/786,704

(22) Filed: Jul. 29, 2024

(30) Foreign Application Priority Data
Sep. 19, 2023 (JP) 2023-150849

(51) Int. Cl. B60J 10/76; B60J 5/04

(52) U.S. Cl. CPC B60J 10/76; B60J 5/0402

(57) ABSTRACT

A glass run includes, as a basic framework, a bottom wall, a vehicle outer side wall, and a vehicle inner side wall. The glass run is attached to a door frame and guides an up and down movement of a door glass. A hard portion higher in hardness than a material constituting the vehicle outer side wall is formed inside from a vehicle inner surface of the vehicle outer side wall on the vehicle outer side wall.

### CROSS REFERENCE TO RELATED APPLICATION

This application claims the priority benefit of Japanese Patent Application No. 2023-150849 filed on Sep. 19, 2023. The entirely of the above-mentioned patent application is hereby incorporated by reference herein and made a part of this application.

### BACKGROUND OF THE INVENTION

### (1) Field of the Invention

The present invention relates to a glass run attached to a door frame formed on a door of a vehicle such as an automobile.

### (2) Description of Related Art

Improving quietness of a vehicle such as an automobile increases comfort of a passenger and thus, a degree of appeal for improving product competitiveness is higher. In an electric automobile expected to spread rapidly in the future, a conventionally installed engine is removed. When an engine sound has been removed, remaining noise is mainly road noise and wind noise. Thus, countermeasures to reduce these noises have been increasing required.

The wind noise is a sound generated by wind hitting a vehicle when the vehicle is traveling; and the sound generated outside a passenger compartment transmits through a vehicle body to reach the passenger compartment. It is known that a door glass near the passenger's ears in the passenger compartment contributes most to the wind noise in the sound transmitting path. Countermeasures, such as increasing a thickness of the door glass and setting an acoustic glass have been implemented, which however causes an increase in weight and cost.

In addition to the door glass, a glass run as a sealing material between the door glass and a door frame may reduce noise in particularly a high frequency range of 1 kHz or higher, and, as a technique for reducing noise due to wind noise, it is also possible to reduce vibration by using so-called impedance matching by which vibration energy of the door glass is efficiently flown and dissipated to a glass run in contact with the door glass, and studies on increasing this reduction effect are being conducted (for example, Japanese Patent Application Laid-Open No. 2023-053894, No. 2023-106008).

FIG. 4 is a technique described in Japanese Patent Application Laid-Open No. 2023-053894. In Japanese Patent Application Laid-Open No. 2023-053894, a glass run 100 includes, as a basic framework, a bottom wall 200, a vehicle outer side wall 300, and a vehicle inner side wall 400. The basic framework is attached to a door frame groove 500 formed at a door frame to guide an up and down movement of a door glass 600. At the vehicle inner side of the vehicle outer side wall 300, a thick portion 320, which protrudes to the vehicle inner side, comes into sliding contact with the door glass 600, and has higher hardness than that of a vehicle outer side wall body part 310 of the vehicle outer side wall 300 is formed. Therefore, the rigidity of the glass run 100 increases, the rigidity difference between the door glass 600 and the vehicle outer side wall 300 decreases, and the vibration energy of the door glass can be efficiently flowed and dissipated at the time of sliding contact with the door glass by impedance matching. It is described that as a result, noise due to wind noise can be reduced.

FIG. 5 is a technique described in Japanese Patent Application Laid-Open No. 2023-106008. Japanese Patent Application Laid-Open No. 2023-106008 is a glass run 100 including, as a basic framework, a bottom wall 200, a vehicle outer side wall 300, and a vehicle inner side wall 400. The basic framework is attached to a door frame groove 500 formed at a door frame to guide an up and down movement of a door glass 600. At the vehicle inner side of the vehicle outer side wall 300 of the glass run 100, a thick portion 320, which protrudes to the vehicle inner side, comes into sliding contact with the door glass 600, and has higher hardness than that of the vehicle outer side wall 300 is formed. When a thickness of the thick portion 320 is t1 and a sum of thicknesses of the thick portion 320 and the vehicle outer side wall 300 is T, t1 is equal to or greater than 0.4 T and equal to or less than 1.0 T.

In FIG. 5, the thick portion 320 is formed by being divided into a part in sliding contact with the door glass 600 and a part exposed to the vehicle outer side of the vehicle outer side wall 300. The thickness of the thick portion 320 on the door glass 600 side is t2, the thickness of the thick portion 320 exposed to the vehicle outer side is t3, and the sum of those thicknesses is a thickness t1 of the thick portion 320, i.e., t1=t2+t3, and t1=0.7 T.

It is described that as a result, the rigidity of the glass run 100 can be increased by forming the thick portion 320 thick, and even in a case where a rib 350 having a protruding shape is formed on the vehicle inner side of the thick portion 320, the effect of the thick portion 320 is sufficiently exerted and the reduction effect of noise due to wind noise can be increased.

### SUMMARY OF THE INVENTION

The shape of the door frame often varies from one vehicle type to another, and accordingly, the gap shape between the door glass and the door frame also varies. For example, when the gap between the door glass and the vehicle outer side wall is narrow, it is difficult to form a thick portion as illustrated in FIG. 4 (Japanese Patent Application Laid-Open No. 2023-053894) and FIG. 5 (Japanese Patent Application Laid-Open No. 2023-106008) by partially protruding.

The present invention provides a glass run in which rigidity of the glass run including a vehicle outer side wall is increased when a gap with a door glass is narrow on the vehicle outer side wall, in particular.

According to a first disclosed aspect, a glass run includes, as a basic framework, a bottom wall, a vehicle outer side wall, and a vehicle inner side wall. The glass run is attached to a door frame and guides an up and down movement of a door glass. A hard portion higher in hardness than a material constituting the vehicle outer side wall is formed inside from a vehicle inner surface of the vehicle outer side wall on the vehicle outer side wall.

According to the first disclosed aspect, since the hard portion higher in hardness than a material constituting the vehicle outer side wall is formed inside from the vehicle inner surface of the vehicle outer side wall on the vehicle outer side wall, the hard portion can be brought into contact with the door glass even when the gap between the vehicle outer side wall and the door glass is narrow. Since the hard portion is formed on the vehicle outer side wall, the rigidity of the glass run including the vehicle outer side wall increases, and the vibration energy of the door glass can be efficiently caused to flow and dissipate through the hard portion to the vehicle outer side wall, i.e., the glass run by impedance matching due to a decrease in the rigidity difference from the door glass. As a result, noise due to wind noise can be reduced.

Here, the “rigidity of the glass run” is expressed by an amount of increase in a reaction force from the glass run with respect to an amount of displacement of an area where the door glass presses the glass run. Accordingly, when “the rigidity of the glass run increases”, a slope (gradient) increases in a relationship between the displacement and the reaction force.

According to a second disclosed aspect, in the glass run, the hard portion is formed in a substantially entire region from a vicinity of the vehicle outer side wall side of a coupling part between the bottom wall and the vehicle outer side wall to a vehicle inner side of the vehicle outer side wall.

According to the second disclosed aspect, since the hard portion is formed in a substantially entire region from a vicinity of the vehicle outer side wall side of a coupling part between the bottom wall and the vehicle outer side wall to a vehicle inner side of the vehicle outer side wall, the hard portion can be in sliding contact with the door glass in a wide region on the vehicle inner side of the vehicle outer side wall. As a result, also when the hard portion is formed inside from the vehicle inner surface of the vehicle outer side wall, the vibration energy of the door glass can be efficiently caused to flow and dissipate through the hard portion at the time of sliding contact with the door glass, and therefore noise due to wind noise can be reduced.

According to a third disclosed aspect, in the glass run, the hard portion is formed beyond a tip end portion of the door frame when the glass run is attached to the door frame.

According to the third disclosed aspect, since the hard portion is formed beyond a tip end portion of the door frame when the glass run is attached to the door frame, the hard portion is formed in a wide region from the vehicle inner surface of the vehicle outer side wall to an inside, rigidity of the vehicle outer side wall is increased, and vibration energy of the door glass can be caused to efficiently flow and dissipate to the hard portion at the time of sliding contact with the door glass, and therefore, noise due to wind noise can be reduced, and deformation of the vehicle outer side wall beyond the door frame can be suppressed at the time of sliding contact with the door glass.

According to a fourth disclosed aspect, in the glass run, a vehicle outer hard portion higher in hardness than a material constituting the vehicle outer side wall is formed on a vehicle outer side of the vehicle outer side wall, and the vehicle outer hard portion comes into contact with the door frame.

According to the fourth disclosed aspect, since the vehicle outer hard portion higher in hardness than the material constituting the vehicle outer side wall is formed on the vehicle outer side of the vehicle outer side wall, and the vehicle outer hard portion comes into contact with the door frame, the rigidity of the glass run including the vehicle outer side wall can be further increased by the vehicle outer side wall being held between the door frame and the door glass. As a result, since the vibration energy of the door glass can be caused to more efficiently flow and dissipate by impedance matching due to a further decrease in the rigidity difference between the door glass and the glass run, noise due to wind noise can be further reduced.

According to a fifth disclosed aspect, in the glass run at the fourth disclosed aspect, the vehicle outer hard portion is formed beyond a tip end portion of the door frame when the glass run is attached to the door frame.

According to the fifth disclosed aspect, since the vehicle outer hard portion is formed beyond a tip end portion of the door frame when the glass run is attached to the door frame, the vehicle outer hard portion is formed in a wide range also on the vehicle outer side of the vehicle outer side wall, and the rigidity of the glass run including the vehicle outer side wall can be increased together with the hard portion formed on the vehicle outer side wall. As a result, since the vibration energy of the door glass can be caused to more efficiently flow and dissipate by impedance matching due to a further decrease in the rigidity difference between the door glass and the vehicle outer side wall, noise due to wind noise can be further reduced.

According to a sixth disclosed aspect, in the glass run, a rib having a protruding shape protruding on a vehicle inner side is formed on the vehicle inner side of the hard portion.

According to the sixth disclosed aspect, since the rib having a protruding shape protruding on the vehicle inner side is formed on the vehicle inner side of the hard portion, it is possible to prevent generation of abnormal noise associated with dust, dirt, foreign matters, and the like caught in the hard portion when the door glass moves up and down.

### BRIEF DESCRIPTION OF THE DRAWINGS

FIG. 1 is a front view of an automobile door;

FIG. 2 is a front view illustrating a glass run used for the door frame of FIG. 1;

FIG. 3 is a cross-sectional view of a glass run according to an embodiment of the present invention, corresponding to line X-X of FIG. 1;

FIG. 4 is a cross-sectional view illustrating a known glass run, and is a cross-sectional view corresponding to line X-X of FIG. 1 (Japanese Patent Application Laid-Open No. 2023-053894); and

FIG. 5 is a cross-sectional view illustrating a known glass run, and is a cross-sectional view corresponding to line X-X of FIG. 1 (Japanese Patent Application Laid-Open No. 2023-106008).

### DETAILED DESCRIPTION OF PREFERRED EMBODIMENTS

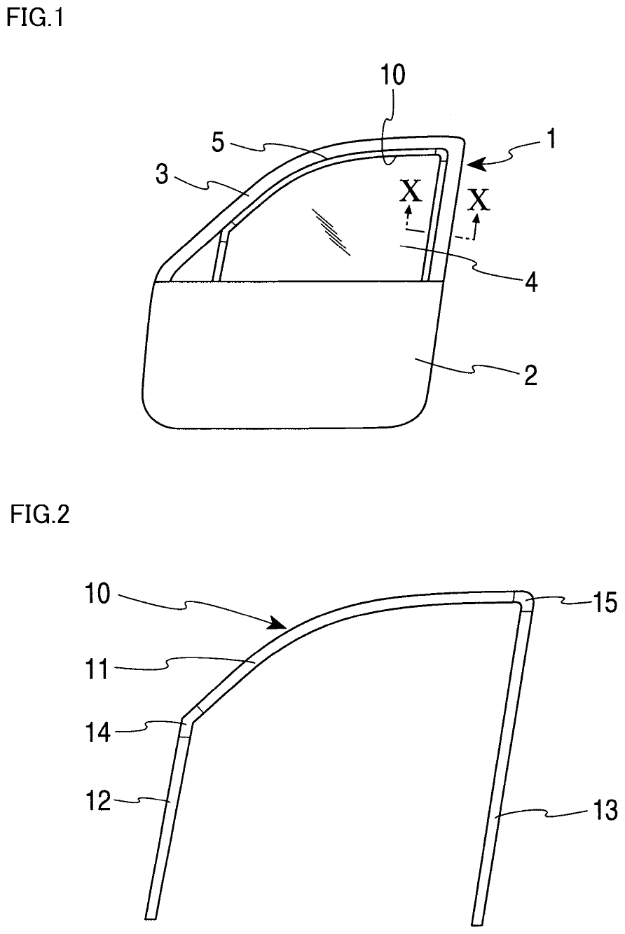

An embodiment of the present invention will be described with reference to FIGS. 1 to 3. FIG. 1 is a front view of a front door 1 on a left side of an automobile as seen from a vehicle outer side. The front door 1 includes a door body 2, and a door frame 3 is attached to an upper edge of the door body 2. The door frame 3 and the upper edge of the door body 2 form a window opening. A glass run 10 is attached to an inner peripheral edge of the window opening and the inside of the door body 2 to guide an up and down movement of the door glass 4. The present invention is applicable not only to the front door 1 on the left side but also to a front door on a right side, rear doors on left and right sides. The present invention is applicable to a sliding door at which the door glass moves up and down.

FIG. 2 is a simplified front view of the glass run 10 alone, as seen from the vehicle outer side. The glass run 10 includes a first extruded portion 11 corresponding to a lateral frame of the door frame 3, a second extruded portion 12 corresponding to a vertical frame of the door frame 3 at a front side of the front door 1, and a third extruded portion 13 corresponding to a vertical frame of the door frame 3 at a rear side of the front door 1. A front end portion of the first extruded portion 11 is connected to an upper end portion of the second extruded portion 12 by a first molded portion 14. A rear end portion of the first extruded portion 11 is connected to an upper end portion of the third extruded portion 13 by a second molded portion 15.

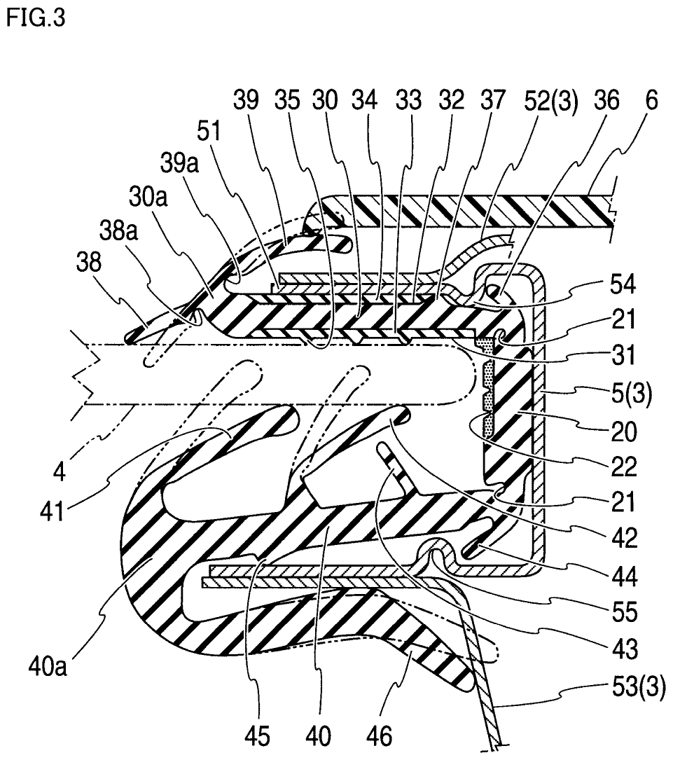

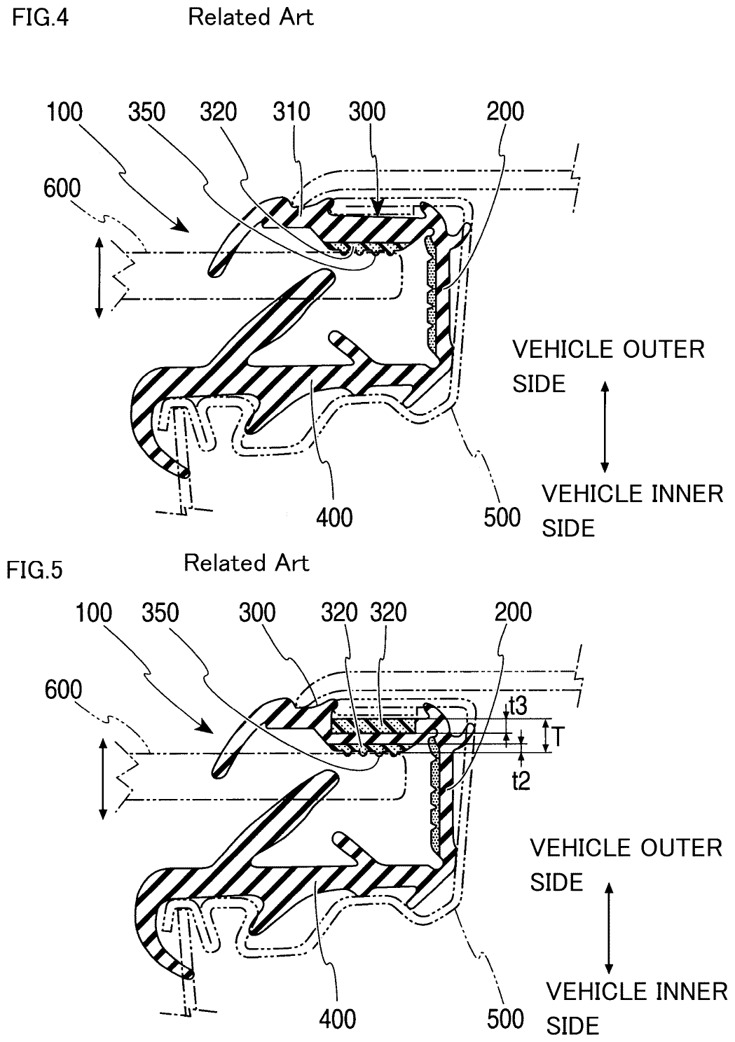

FIG. 3 is a cross-sectional view corresponding to line X-X of FIG. 1, i.e., of the third extruded portion 13, and this cross-section is uniformly formed in the third extruded portion 13. The glass run 10 includes, as a basic framework, a bottom wall 20, a vehicle outer side wall 30, and a vehicle inner side wall 40, and is formed in a channel shape (substantially U-shaped in cross-section). A coupling portion of the bottom wall 20, the vehicle outer side wall 30, and the vehicle inner side wall 40 is coupled in a freely expandable manner by grooves 21 and 21 on the vehicle outer side and the vehicle inner side. The vehicle inner side wall 40 is formed to be larger than the vehicle outer side wall 30, and the vehicle inner side is formed to be large and asymmetric.

The bottom wall 20, the vehicle outer side wall 30, and the vehicle inner side wall 40 are attached in a door frame groove 5 of the door frame 3. The door frame 3 is a press door in which an outer frame 52 is connected to the vehicle outer side of the door frame groove 5 and an inner frame 53 is connected to the vehicle inner side of the door frame groove 5.

The bottom wall 20 is formed in a substantially plate shape, and a plurality of bottom wall recesses 22 are formed in a longitudinal direction continuously in parallel on an inner surface (door glass 4 side) of the bottom wall 20. When the glass run 10 is attached in the door frame groove 5 of the door frame 3, the bottom wall 20 comes into contact with the door frame groove 5.

A vehicle outer holding lip 36 is formed in the vicinity of a coupling portion with the bottom wall 20 on the vehicle outer side of the vehicle outer side wall 30, and a vehicle outer holding rib 37 having a substantially triangular cross-section is formed to protrude on a vehicle outer side wall tip end portion 30a side of the vehicle outer side wall 30 of the vehicle outer holding lip 36. When the glass run 10 is attached to the door frame groove 5 of the door frame 3, the vehicle outer holding lip 36 gets over a vehicle outer recess 54 of the door frame groove 5, and holds the vehicle outer side wall 30 in the door frame groove 5 with the vehicle outer recess 54 being held between the vehicle outer holding lip 36 and the vehicle outer holding rib 37.

The vehicle outer side wall 30 is formed substantially in a linear shape, and the vehicle outer side wall tip end portion 30a is curved to the vehicle outer side. By curving the vehicle outer side wall tip end portion 30a to the vehicle outer side, a coupling part of a vehicle outer cover lip 38 formed at the vehicle outer side wall tip end portion 30a described later with the vehicle outer side wall 30 can be provided on the vehicle outer side, and the curve of the vehicle outer cover lip 38 to the vehicle outer side accompanying the contact with the door glass 4 is facilitated.

On the vehicle inner side of the vehicle outer side wall 30, a hard portion 33 higher in hardness than the material constituting the vehicle outer side wall 30 is formed from the vehicle inner surface 31 to the inside of the vehicle outer side wall 30 in a region excluding the vehicle outer side wall tip end portion 30a that is curved of the vehicle outer side wall 30 from the vicinity of the groove 21, which is the coupling part with the bottom wall 20 of the vehicle outer side wall 30, i.e., substantially the entire region of the linear part. The hard portion 33 is exposed on the vehicle inner side of the vehicle outer side wall 30.

As is clear from FIG. 3, when the glass run 10 is attached in the door frame groove 5 of the door frame 3, the hard portion 33 is formed beyond a tip end portion 51 of the door frame groove 5.

On a vehicle inner surface of the hard portion 33, a plurality of (three in FIG. 3) the ribs 35 having a protruding shape are formed in a longitudinal direction continuously in parallel.

In a region on the vehicle outer side of the vehicle outer side wall 30, the region connecting a triangular top of the vehicle outer holding rib 37 and the curved portion of the vehicle outer side wall tip end portion 30a of the vehicle outer side wall 30, a vehicle outer hard portion 34 higher in hardness than the material constituting the vehicle outer side wall 30 is formed from a vehicle outer surface 32 of the vehicle outer side wall 30. The vehicle outer hard portion 34 and the hard portion 33 are made of the same material. Note that the vehicle outer hard portion 34 and the hard portion 33 may be formed of materials having different hardness.

When the glass run 10 is attached to the door frame groove 5, the vehicle outer hard portion 34 comes into contact with the inner surface of the door frame groove 5.

As is clear from FIG. 3, when the glass run 10 is attached in the door frame groove 5 of the door frame 3, the vehicle outer hard portion 34 is formed beyond the tip end portion 51 of the door frame groove 5.

The vehicle outer cover lip 38 is formed in a direction of the door glass 4 and toward the opposite side to the bottom wall 20 on the vehicle outer side wall tip end portion 30a of the vehicle outer side wall 30. A vehicle outer cover lip recess 38a is formed on the vehicle inner side of a root part of the vehicle outer cover lip 38 to facilitate curving of the vehicle outer cover lip 38 to the vehicle outer side accompanying contact of the vehicle outer cover lip 38 with the door glass 4. The vehicle outer cover lip 38 comes into contact with the surface of the vehicle outer side of the door glass 4 to suppress entry of rainwater and dust into the hard portion 33 and prevent deterioration of the hard portion 33. Sealing property with the door glass 4 is improved. Note that the vehicle outer cover lip 38 is sometimes called a vehicle outer seal lip in terms of improving the sealability with the door glass 4.

A locking lip 39 is formed toward the vehicle outer side at a coupling part between the vehicle outer cover lip 38 and the vehicle outer side wall tip end portion 30a, which is the vehicle outer side wall tip end portion 30a of the vehicle outer side wall 30. The locking lip 39 comes into contact with the vehicle inner side of an end portion of a pillar garnish 6 and seals a gap between the pillar garnish 6 and the surface of the door glass 4 together with the vehicle outer cover lip 38. A locking lip recess 39a is formed at a root part of the locking lip 39 to facilitate curving of the locking lip 39 to the vehicle inner side accompanying contact with the end portion of the pillar garnish 6.

On the vehicle outer side of the vehicle inner side wall 40, a first vehicle inner seal lip 41 and a second vehicle inner seal lip 42 are formed, the first vehicle inner seal lip 41 and the second vehicle inner seal lip 42 extending from between a vehicle inner side wall tip end portion 40a and the bottom wall 20 to the vehicle outer side and the bottom wall 20 side, and having surfaces of the vehicle outer side in sliding contact with the door glass 4.

A sub lip 43 is formed in an opposite direction to the second vehicle inner seal lip 42 on the vehicle outer side of the vehicle inner side wall 40 and on the bottom wall 20 side relative to the second vehicle inner seal lip 42. The sub lip 43 does not come into contact with a vehicle inner surface of the second vehicle inner seal lip 42 at the time of sliding contact with the door glass 4. The sub lip 43 comes into contact with the vehicle inner surface of the second vehicle inner seal lip 42 and presses the second vehicle inner seal lip 42 to the vehicle outer side when the door glass 4 greatly moves toward the vehicle inner side, such as when the door is strongly closed or when the vehicle travels on a rough road or the like in a state where the door glass 4 is slightly opened, thereby preventing separation between the door glass 4 and the second vehicle inner seal lip 42 and generation of a tap noise (abnormal noise) accompanying the contact.

On the vehicle inner side of the vehicle inner side wall 40, a vehicle inner holding lip 44 is formed in the vicinity of a coupling portion with the bottom wall 20, and a vehicle inner holding rib 45 is formed on the vehicle inner side wall tip end portion 40a side of the vehicle inner side wall 40. When the glass run 10 is attached to the door frame groove 5 of the door frame 3, the vehicle inner holding lip 44 gets over a vehicle inner recess 55 of the door frame groove 5, and holds the vehicle inner side wall 40 in the door frame groove 5 with the vehicle inner recess 55 being held between the vehicle inner holding lip 44 and the vehicle inner holding rib 45.

A cover lip 46 is formed on the vehicle inner side and toward the bottom wall 20 direction on the vehicle inner side wall tip end portion 40a of the vehicle inner side wall 40. The cover lip 46 comes into contact with the inner frame 53, prevents rainwater, dust, and noise from entering, and improves the sealability with the inner frame 53.

As described above in detail, according to the present embodiment, the following effects can be obtained.
(1) In the present embodiment, since the hard portion 33 and the vehicle outer hard portion 34 are uniformly formed in the third extruded portion 13, they can be easily formed by extrusion and are excellent in productivity.
(2) In the present embodiment, since the hard portion 33 higher in hardness than the material constituting the vehicle outer side wall 30 is formed from the vehicle inner surface 31 to the inside of the vehicle outer side wall 30, the hard portion 33 can be brought into contact with the door glass 4 even when the gap between the vehicle outer side wall 30 and the door glass 4 is narrow. Since the hard portion 33 is formed on the vehicle outer side wall 30 and the hard portion 33 and the door glass 4 come into sliding contact with each other, a rigidity difference between the door glass 4 and the vehicle outer side wall 30 is reduced, and vibration energy of the door glass 4 can be caused to efficiently flow and dissipate to the hard portion 33 by impedance matching. As a result, noise due to wind noise can be reduced.
(3) In the present embodiment, since the hard portion 33 is formed in a region excluding the vehicle outer side wall tip end portion 30a that is curved of the vehicle outer side wall 30 from the vicinity of the groove 21, which is the coupling part with the bottom wall 20 of the vehicle outer side wall 30, i.e., substantially the entire region of the linear part, the hard portion 33 can come into sliding contact with the door glass 4 in a wide region on the vehicle inner side of the vehicle outer side wall 30. As a result, since also when the hard portion 33 is formed inside from the vehicle inner surface 31 of the vehicle outer side wall 30, the vibration energy of the door glass 4 can be caused to efficiently flow and dissipate to the hard portion 33 at the time of sliding contact with the door glass 4, noise due to wind noise can be reduced.
(4) In the present embodiment, since the hard portion 33 is formed beyond the tip end portion 51 of the door frame groove 5, the hard portion 33 is formed in a wide region from the vehicle inner surface 31 of the vehicle outer side wall 30 to the inside, the rigidity of the vehicle outer side wall 30 is increased, and the vibration energy of the door glass 4 can be caused to efficiently flow and dissipate to the hard portion 33 at the time of sliding contact with the door glass 4, and therefore, noise due to wind noise can be reduced, and deformation of the vehicle outer side wall 30 beyond the door frame groove 5 (door frame 3) can be suppressed at the time of sliding contact with the door glass 4.
(5) In the present embodiment, since in the region on the vehicle outer side of the vehicle outer side wall 30, the region connecting the vehicle outer holding rib 37 and the curved portion of the vehicle outer side wall tip end portion 30a of the vehicle outer side wall 30, a vehicle outer hard portion 34 higher in hardness than the material constituting the vehicle outer side wall 30 is formed from a vehicle outer surface 32 of the vehicle outer side wall 30, the rigidity of the vehicle outer side wall 30 is further increased.
(6) In the present embodiment, when the glass run 10 is attached to the door frame groove 5, since the vehicle outer hard portion 34 comes into contact with the inner surface of the door frame groove 5, the vehicle outer side wall 30 is held between the door frame groove 5 and the door glass 4, i.e., the hard portion 33 is held by the door glass 4 and the vehicle outer hard portion 34 is held by the door frame groove 5, whereby the rigidity of the vehicle outer side wall 30 can be further increased. As a result, since the vibration energy of the door glass 4 can be caused to more efficiently flow and dissipate by impedance matching due to a further decrease of the rigidity difference between the door glass 4 and the glass run 10, noise due to wind noise can be further reduced.
(7) In the present embodiment, since the vehicle outer hard portion 34 is formed beyond the tip end portion 51 of the door frame groove 5 when the glass run 10 is attached to the door frame 3, the vehicle outer hard portion 34 is formed in a wide range also on the vehicle outer side of the vehicle outer side wall 30, and the rigidity of the glass run 10 including the vehicle outer side wall 30 can be increased together with the hard portion 33 formed on the vehicle inner side.
(8) In the present embodiment, since on the vehicle inner surface of the hard portion 33, the plurality of (three in FIG. 3) ribs 35 having a protruding shape are formed in the longitudinal direction continuously in parallel, it is possible to prevent generation of abnormal noise associated with dust, dirt, foreign matters, and the like caught between the hard portion 33 and the door glass 4 when the door glass 4 moves up and down.
(9) In the present embodiment, since the vehicle outer cover lip 38 is formed in a direction of the door glass 4 and toward the opposite side to the bottom wall 20 on the vehicle outer side wall tip end portion 30a of the vehicle outer side wall 30, the hard portion 33 can be extended to the vicinity of the vehicle outer side wall tip end portion 30a.
(10) In the present embodiment, since the vehicle outer cover lip recess 38a is formed on the vehicle inner side of the root part of the vehicle outer cover lip 38, the vehicle outer cover lip 38 is easily curved to the vehicle outer side accompanying the contact of the vehicle outer cover lip 38 with the door glass 4, and the door glass 4 easily moves on the vehicle outer side. As a result, the door glass 4 can be easily brought into contact with the hard portion 33.

As described above, since the hard portion 33 is formed in a region excluding the vehicle outer side wall tip end portion 30a that is curved of the vehicle outer side wall 30 from the vicinity of the groove 21, which is the coupling part with the bottom wall 20 of the vehicle outer side wall 30, i.e., substantially the entire region of the linear part, the effect of the hard portion 33 is sufficiently exerted, and the reduction effect of noise due to wind noise can be increased even when the rib 35 having a protruding shape is formed on the vehicle inner side of the hard portion 33.

In the present embodiment, the glass run 10 excluding the hard portion 33 and the vehicle outer hard portion 34 was produced by extrusion using thermoplastic elastomer olefin (TPO) having International Rubber Hardness Degrees (IRHD) of 80±5, and the hard portion 33 and the vehicle outer hard portion 34 were produced by extrusion using TPO having IRHD of 100±5.

In the embodiment of the present invention, the material constituting the glass run 10 can be formed of rubber, a thermoplastic elastomer, a soft synthetic resin, or the like. In the case of rubber, ethylene propylene diene rubber (EPDM) is desirable, and as a thermoplastic elastomer, thermoplastic elastomer olefin (TPO) or crosslinked thermoplastic elastomer (TPV) is desirable from the viewpoint of weather resistance, recycling, cost, and the like. The hard portion 33 and the vehicle outer hard portion 34 can be formed using polypropylene (PP).

When the present invention is carried out, it is not limited to the above embodiment, and various modifications can be made without departing from the object of the present invention.

For example, the glass run 10 of the above embodiment can be applied to the first extruded portion 11 and the second extruded portion 12 in FIG. 2.

What is claimed is:

1. A glass run including, as a basic framework, a bottom wall, a vehicle outer side wall, and a vehicle inner side wall, the glass run being attached to a door frame and guiding an up and down movement of a door glass, wherein
a hard portion higher in hardness than a material constituting the vehicle outer side wall is formed inside from a vehicle inner surface of the vehicle outer side wall on the vehicle outer side wall.

2. The glass run according to claim 1, wherein the hard portion is formed in a substantially entire region from a vicinity of the vehicle outer side wall side of a coupling part between the bottom wall and the vehicle outer side wall to a vehicle inner side of the vehicle outer side wall.

3. The glass run according to claim 1, wherein the hard portion is formed beyond a tip end portion of the door frame when the glass run is attached to the door frame.

4. The glass run according to claim 1, wherein a vehicle outer hard portion higher in hardness than a material constituting the vehicle outer side wall is formed on a vehicle outer side of the vehicle outer side wall, and the vehicle outer hard portion comes into contact with the door frame.

5. The glass run according to claim 4, wherein the vehicle outer hard portion is formed beyond a tip end portion of the door frame when the glass run is attached to the door frame.

6. The glass run according to claim 1, wherein a rib having a protruding shape protruding on a vehicle inner side is formed on the vehicle inner side of the hard portion.
